(19) United States
(12) Patent Application Publication
(10) Pub. No.: US 2016/0270431 A1
(43) Pub. Date: Sep. 22, 2016

(54) Steaming System for Food Processing

(71) Applicant: CJ Cheiljedang Corporation, Seoul (KR)

(72) Inventors: Sang Goo Yun, Gyeonggi-do (KR); Bong Jin Jang, Busan (KR)

(21) Appl. No.: 15/049,887

(22) Filed: Feb. 22, 2016

(30) Foreign Application Priority Data
Mar. 16, 2015 (KR) 10-2015-0035977

(51) Int. Cl. A23L 3/00; A23L 3/005

(52) U.S. Cl. CPC A23L 3/001; A23P 1/105; A23L 3/005

(57) ABSTRACT

The present invention relates to a steaming system for food processing including: a first conveyor disposed in a molding section for molding processed foods so as to convey the processed foods therealong; a second conveyor disposed in a steaming section formed at the rear end of the molding section to steam the processed foods; a third conveyor disposed in a carrying out section for radiating the heat of the processed foods steamed in the steaming section and carrying the processed foods out; and bridge units located between the first conveyor and the second conveyor and between the second conveyor and the third conveyor so as to assist gentle moving between the sections of the processed foods.

### RELATED APPLICATIONS

This application claims the benefit of Korean application number 10-2015-0035977 filed on Mar. 16, 2015 and entitled “Steaming system for food processing,” the content of which is hereby incorporated by reference in its entirety and for all purposes.

### BACKGROUND OF THE INVENTION

1. Field of the Invention

The present invention relates to a steaming system for food processing, and more particularly, to a steaming system for food processing that is capable of steaming products, such as dumplings, wheat noodles (Japanese noodles), and instant noodles, while continuously moving the products along conveyors, thus minimizing the loss of heat radiated from the conveyors.

2. Background of the Related Art

Generally, a steaming system for food processing is used to apply wet steam to first processed foods, such as dumplings, wheat noodles, and instant noodles moving continuously along a conveyor and thus to provide the steamed processed foods.

FIG. 1 is a view showing a configuration of a conventional steaming system for food processing.

As shown in FIG. 1, a conventional steaming system for food processing includes a molding section 10 at which a molding machine is disposed formed at the front end thereof, a steaming section 20 connected to the molding section 10 to apply steam to processed foods, and a carrying out section 30 disposed at the rear side of the steaming section 20 to radiate heat from the steamed processed foods and to carry them out.

Further, a conveyor 40 is continuously disposed along the longitudinal directions of the molding section 10, the steaming section 20 and the carrying out section 30, and the conveyor 40 is formed of a one body net (mesh) conveyor.

Accordingly, the processed foods are first processed in the molding section 10 along the conveyor 40, and they are continuously steamed in the steaming section 20 along the conveyor 40.

In the steaming section 20, there are a boiler 21 for heating water to generate wet steam and a steam pipe 22 for supplying the heated wet steam to the processed foods, so that the steaming section 20 is kept at a temperature of about 99° C., thus steaming the processed foods moving along the conveyor 40.

In the carrying out section 30, next, the processed foods after passing through the steaming section 20 are cool off and thus carried out for packaging process.

The conveyor 40, which is returnable as a one body in the conventional steaming system, is heated while passing through the steaming section 20 and then exposed to the air in the carrying out section 30, so that the heat of about 35% is radiated from the conveyor 40, as shown in Table of FIG. 2. Next, the conveyor 40 is returned to the molding section 10 and cooled to a normal temperature, and after that, it advances to the steaming section 20. The cycle is repeatedly carried out. So as to raise the temperature of the conveyor 40 radiated and cooled up to the temperature needed in the steaming section 20, lots of energy and time should be consumed.

Another example of the conventional steaming system for food processing is disclosed in Korean Patent Registration No. 10-0497498 in which the wet steam exhausted after foods are steamed in a steaming chamber is collected and reused, thus reducing the quantity of energy used.

### SUMMARY OF THE INVENTION

Accordingly, the present invention has been made in view of the above-mentioned problems occurring in the prior art, and it is an object of the present invention to provide a steaming system for food processing that is capable of locating individual conveyors in a molding section, a steaming section and a carrying out section and providing bridge units for connecting the individual conveyors with each other, so that the temperatures required in the respective sections can be maintained to reduce the quantity of energy loss radiated from the conveyors returned.

It is another object of the present invention to provide a steaming system for food processing that is capable of providing individual conveyors maintained at given temperatures to prevent the sticking of processed foods to the conveyor caused by the temperature difference of the conveyor in the conventional steaming system, thus reducing defective rates of foods and further shortening the production processing time of the foods through the aligned movement of the foods.

To accomplish the above-mentioned objects, according to the present invention, there is provided a steaming system for food processing including: a first conveyor disposed in a molding section for molding processed foods so as to convey the processed foods therealong; a second conveyor disposed in a steaming section formed at the rear end of the molding section to steam the processed foods; a third conveyor disposed in a carrying out section for radiating the heat of the processed foods steamed in the steaming section and carrying the processed foods out; and bridge units located between the first conveyor and the second conveyor and between the second conveyor and the third conveyor so as to assist gentle moving between the sections of the processed foods.

According to the present invention, desirably, each bridge units includes: a guide roller located in axial directions of the first conveyor, the second conveyor and the third conveyor; and a motor for rotating the guide roller.

According to the present invention, desirably, the guide rollers of the bridge units have the same lengths as the axial lengths of the first conveyor, the second conveyor and the third conveyor and are driven at the same rotation speed as the return rotation speeds of the first conveyor, the second conveyor and the third conveyor.

According to the present invention, desirably, the steaming section is kept at a temperature in the range of 90 to 110° C.

According to the present invention, desirably, the first conveyor, the second conveyor and the third conveyor are net conveyors, and the processed foods are any ones selected from dumplings, wheat noodles, and instant noodles.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view showing a configuration of a conventional steaming system for food processing;

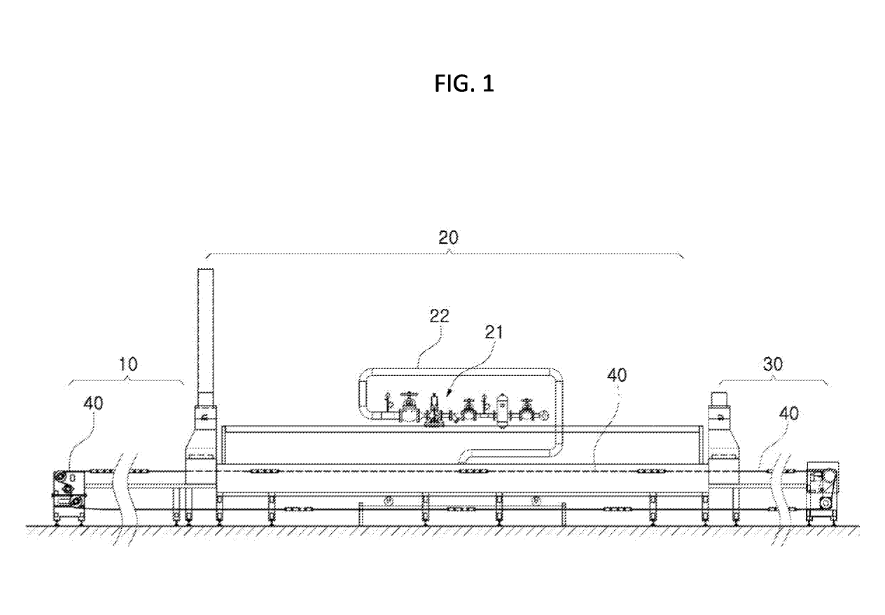

FIG. 2 is a table showing the degrees of energy used in the conventional steaming system for food processing;

FIG. 3 is a front view showing a steaming system for food processing according to the present invention;

FIG. 4 is an enlarged view showing a portion A of FIG. 3; and

FIG. 5 is an enlarged view showing a portion B of

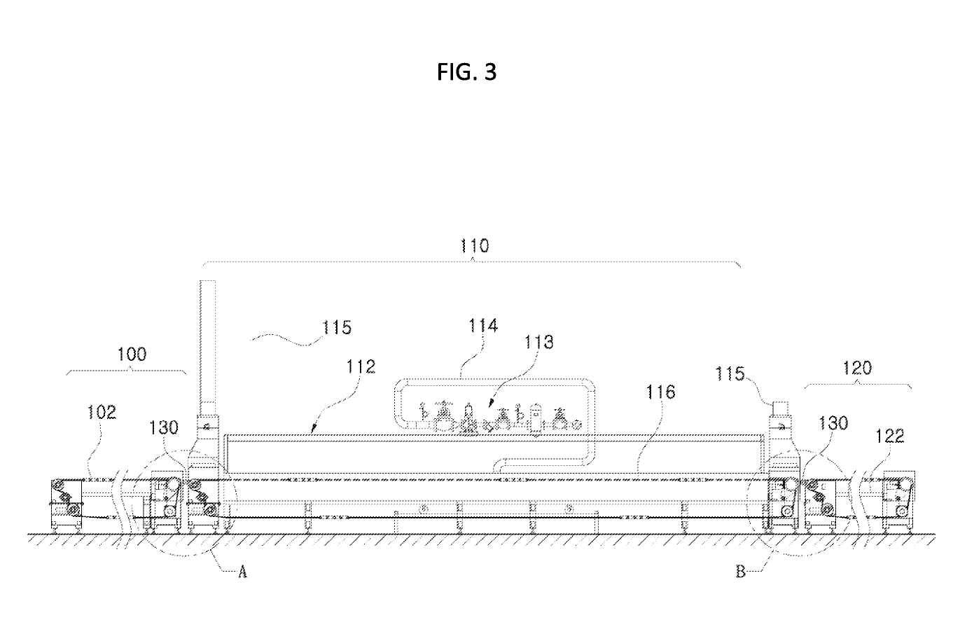

FIG. 3.

### DETAILED DESCRIPTION OF THE PREFERRED EMBODIMENTS

Hereinafter, an explanation on a steaming system for food processing according to the present invention will be in detail given with reference to the attached drawing.

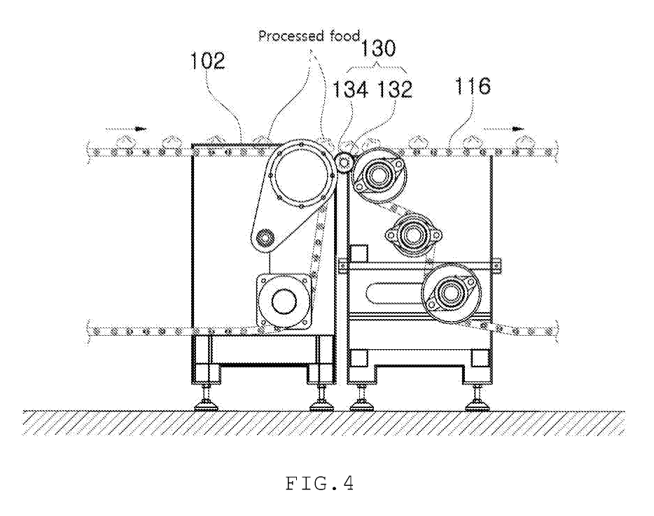

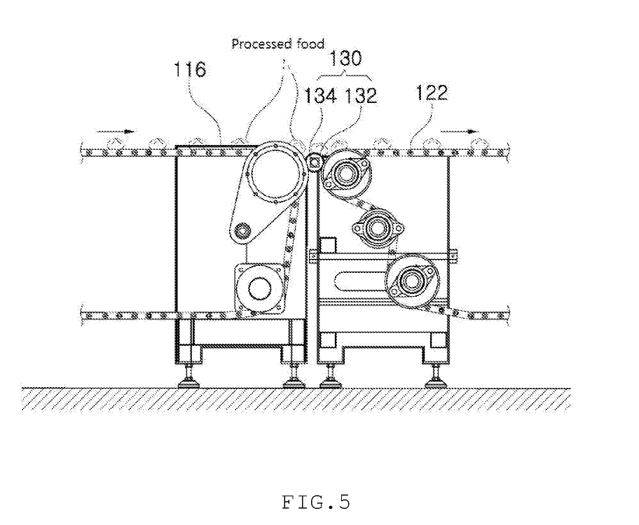

FIG. 3 is a front view showing a steaming system for food processing according to the present invention, FIG. 4 is an enlarged view showing a portion A of FIG. 3, and FIG. 5 is an enlarged view showing a portion B of FIG. 3.

FIG. 3 is a front view showing a steaming system for food processing according to the present invention, and according to the present invention, a steaming system is largely divided into three sections, that is, a molding section 100 for molding processed foods (as shown in FIGS. 4 and 5), a steaming section 110 for steaming the processed foods, and a carrying out section 120 for radiating the heat of the processed foods and carrying the processed foods out.

In this case, the molding section 100 is a place in which the processed foods, such as dumplings, wheat noodles, and instant noodles are first processed through a molding machine (not shown), and in the molding section 10, a first conveyor 102 is located to continuously supply the processed foods.

The first conveyor 102 is independently installed in the molding section 100 in such a manner as to be returnable, and it is formed of a one body net (mesh) conveyor.

The steaming section 110 is formed at the rear end of the molding section 100 to steam the first processed foods.

Desirably, the steaming section 110 has a steaming chamber 112 adapted to apply steam to the processed foods during the movement of the processed foods, and the steaming chamber 112 may be closed in the entire space except the inlet and outlet portions to and from which the processed foods are supplied and discharged.

The steaming chamber 112 has a boiler 113 for heating water to generate wet steam and a steam pipe 114 for supplying the heated wet steam to the processed foods, so that the steaming section 110 is kept at a temperature in the range of to 110° C., desirably, at a temperature of about 99° C., thus steaming the moving processed foods.

Further, the steaming chamber 112 has at least one or more exhaust ducts 115 for exhausting the wet steam remaining after the steaming action to the outside.

In the steaming chamber 112, also, a second conveyor 116 is located to continuously supply the processed foods. The second conveyor 116 is independently installed in the steaming chamber 112 of the steaming section 110 in such a manner as to be returnable. Desirably, the second conveyor 116 is formed of a one body net (mesh) conveyor.

The carrying out section 120 is formed at the rear end of the steaming section 110 to radiate the heat of the steamed processed foods and to carry out the radiated processed foods. Also, a third conveyor 122 is located in the carrying out section 120.

The third conveyor 122 is independently installed in the carrying out section 120 in such a manner as to be returnable, and the third conveyor 122 is formed of a one body net (mesh) conveyor.

On the other hand, as shown in FIGS. 4 and 5, bridge units 130 are disposed between the first conveyor 102 and the second conveyor 116 and between the second conveyor 116 and the third conveyor 122 so as to assist gentle moving between the sections of the processed foods.

Desirably, each bridge unit 130 includes a guide roller 132 and a motor 134 for independently rotating the guide roller 132. The guide rollers 132 of the bridge units 130 have the same lengths as the axial lengths of the first conveyor 102, the second conveyor 116 and the third conveyor 122, and desirably, the guide rollers 132 are driven at the same rotation speed as the return rotation speeds of the first conveyor 102, the second conveyor 116 and the third conveyor 122.

Now, an explanation on the operation of the steaming system for food processing according to the present invention will be given.

The first processed foods through the molding machine (not shown) in the molding section 100 are moved along the first conveyor 102, and the processed foods in the molding section, which almost reach the steaming section 110, are moved over the guide roller 132 rotating at the same speed as the second conveyor 116 by means of the motor 134 and thus moved to the second conveyor 116, as shown in FIG. 4.

The processed foods moved along the second conveyor 116 are steamed with the high temperature wet steam generated from the steaming chamber 112, and the steaming is conducted by keeping the steaming chamber 112 at a temperature in the range of 90 to 110° C., desirably, at a temperature of about 99° C. by means of the boiler 113 and the steam pipe 114 for generating and supplying the wet steam.

In this case, the second conveyor 116, which is returnable only in the steaming chamber 112, is not exposed to the air to constantly maintain the high temperature, so that there is no need to drastically raise the temperature of the second conveyor 116.

The processed foods steamed in the steaming chamber 112 are moved to the third conveyor 122 of the carrying out section 120, and as shown in FIG. 5, that is, the processed foods are moved over the guide roller 132 rotating at the same speed as the third conveyor 122 by means of the motor 134 and thus moved to the third conveyor 122. Through the third conveyor 122, the heat of the processed foods is radiated, and the processed foods are then carried out for next processing.

Accordingly, since the second conveyor 116 returnable only in the steaming chamber 112 is not exposed to the air, energy loss is remarkably reduced to achieve better energy efficiencies than those in the conventional steaming system.

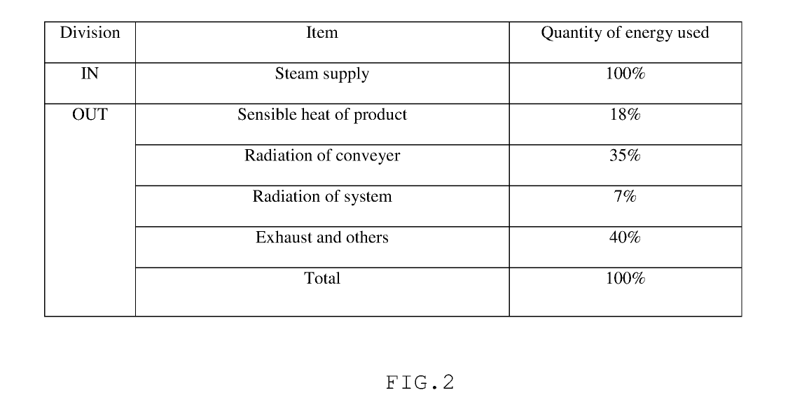

As shown in FIG. 2, if it is assumed that the heat applied to the steaming system is 100%, the heat applied to the products is 18%, the heat radiated from the conveyors is 35%, and the heat radiated from the system is 7%. At this time, the steaming system according to the present invention can apply to the products the heat of about 40% obtained by adding the heat of 35% radiated from the conveyors and the heat of 5% radiated from the system.

This means that the heat of 18% from the heat of 100% applied to the steaming system is applied to the products in the conventional steaming system, but even if only the heat of 60% is applied to the steaming system according to the present invention, the same heat as in the conventional steaming system can be applied to the products. Additionally, the reason why only the heat of 5% from the heat of 7% radiated from the system is applied to the products is that the steaming system is not completely closed even if the inlet ant outlet areas of the steaming section 110 are reduced by means of the guide rollers 132 to minimize the loss of heat.

Further, the bridge units 130, which gently move the processed products between the conveyors individually located in the sections, serve to prevent the processed products from being damaged during the movement along the respective sections, to suppress the processed products from being sticked to the conveyers due to their temperature, and to allow the processed products to be alignedly conveyed.

As described above, the steaming system for food processing according to the present invention is configured wherein the individual conveyors are located in the molding section, the steaming section and the carrying out section, and the bridge units are disposed for connecting the individual conveyors with each other, so that the temperatures required in the respective sections can be maintained to reduce the quantity of energy loss radiated from the conveyors returned, thus remarkably lower the manufacturing cost for food processing.

Furthermore, the steaming system for food processing according to the present invention can reduce defective rates of foods through the individual conveyors kept at the given temperatures and further decrease the production processing time of the foods through the aligned movement of the processed foods.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A steaming system for food processing comprising:
a first conveyor disposed in a molding section for molding processed foods so as to convey the processed foods therealong;
a second conveyor disposed in a steaming section formed at the rear end of the molding section to steam the processed foods;
a third conveyor disposed in a carrying out section for radiating the heat of the processed foods steamed in the steaming section and carrying the processed foods out; and
bridge units located between the first conveyor and the second conveyor and between the second conveyor and the third conveyor so as to assist gentle moving between the sections of the processed foods.

2. The steaming system for food processing according to claim 1, wherein each bridge unit comprises:
a guide roller located in axial directions of the first conveyor, the second conveyor and the third conveyor; and
a motor for rotating the guide roller.

3. The steaming system for food processing according to claim 2, wherein the guide rollers of the bridge units have the same lengths as the axial lengths of the first conveyor, the second conveyor and the third conveyor and are driven at the same rotation speed as the return rotation speeds of the first conveyor, the second conveyor and the third conveyor.

4. The steaming system for food processing according to claim 1, wherein the steaming section is kept at a temperature in the range of 90 to 110° C.

5. The steaming system for food processing according to claim 1, wherein the first conveyor, the second conveyor and the third conveyor are net conveyors.

6. The steaming system for food processing according to claim 1, wherein the processed foods are any ones selected from dumplings, wheat noodles, and instant noodles.
